(19) United States
(12) Patent Application Publication
(10) Pub. No.: US 2007/0136197 A1
(43) Pub. Date: Jun. 14, 2007

(54) METHODS, SYSTEMS, AND COMPUTER PROGRAM PRODUCTS FOR AUTHORIZING A SERVICE REQUEST BASED ON ACCOUNT-HOLDER-CONFIGURED AUTHORIZATION RULES

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/164,987

(22) Filed: Dec. 13, 2005

(51) Int. Cl. G06Q 40/00

(52) U.S. Cl. 705/44

(57) ABSTRACT

Methods, systems, and computer program products are disclosed for authorizing a service request based on account-holder-configured authorization rules. A request for service is received at a service provider from a service requester. The service provider communicates with an authorization agent for applying an account-holder-configured authorization rule specific to the service requester. The request for service is authorized based on the applied authorization rule. The service requester is one of a plurality of users associated with an account and authorization rules for different users associated with the account can be different. At the authorization agent, access for an account holder is provided for defining account-holder-configured authorization rules to be applied by the authorization agent for authorizing the request for service.

### RELATED APPLICATIONS

This application is related to commonly assigned application Ser. No. 11/162,879, filed Sep. 27, 2005, entitled “Methods, Systems, and Computer Program Products for Verifying an Identity of a Service Requester using Presence Information,” the contents of which are incorporated by reference in their entirety.

### BACKGROUND

In a typical non-cash transaction, as is the case with most consumer transactions, the purchaser purchases goods or services from a service provider using funds controlled by an account provider, such as a credit card issuer or bank. The account provider maintains an account for each account holder, with both parties being legally bound by an agreement that specifies, among other things, the limitations placed on the account. The account holder may or may not be the purchaser. For example, the account holder may be an employer and the purchaser may be employees or the account holder may be a parent and the purchaser may be a child of the parent. The account provider ultimately authorizes all transactions on an account in accordance with the agreement. For example, the agreement can specify a maximum outstanding balance on the account. If it results in the maximum outstanding balance being exceeded, the account provider may not authorize a transaction.

For example, when a credit card is used to make a payment, the following sequence generally occurs:

1. The service provider submits an “authorization request” to an authorization network via a point-of-sale terminal, PC software, telephone, fax, the Internet, etc.

2. The network routes the authorization request to the issuing bank or an acquirer. An acquirer is an organization that processes credit card requests and guarantees payment.

3. The bank or acquirer verifies that the account number is valid and that the transaction amount does not exceed the cardholder's credit limit that is based on the cardholder agreement. The authorization also puts a “hold” for the funds on the cardholder's credit limit. If authorized, the service provider is given an authorization number.

4. The service provider uses the authorization number to transmit a deposit transaction to the network.

5. The deposit request is routed to the issuing bank to deposit the net settlement amount into the service provider's bank account.

Generally speaking, all users of the account (i.e., purchasers) are pooled together and treated as a single entity—the account holder—under the agreement. For example, the maximum outstanding balance is applied to the sum of all purchases made by any one authorized to make purchases, whether it be the account holder, his son, his daughter, etc. There is currently no means for the account holder to easily place and/or adjust restrictions on his account that he and other purchasers must follow.

Accordingly, there exists a need for methods, systems, and computer products for authorizing a service request based on account-holder-configured authorization rules.

### SUMMARY

In one aspect of the subject matter disclosed herein, a method for authorizing a service request based on account-holder-configured authorization rules includes receiving a request for service at a service provider from a service requester, communicating with an authorization agent for applying an account-holder-configured authorization rule specific to the service requester, and authorizing the request for service based on the applied authorization rule. The service requester is one of a plurality of users associated with an account and the authorization rules for different users associated with the account can be different.

In another aspect of the subject matter disclosed herein, a method for authorizing a service request based on account-holder-configured authorization rules includes providing access for an account holder for defining account-holder-configured authorization rules to be applied by the authorization agent in authorizing a request for service from a service requester using an account of the account holder, receiving a request for authorization information from a service provider, wherein the request for authorization information is associated with a request for service, and providing the authorization information to the service provider. The authorization information is based on application of at least one authorization rule and the authorization rules for different service requesters associated with the account can be different.

In another aspect of the subject matter disclosed herein, a system for authorizing a service request based on account-holder-configured authorization rules includes means for communicating with a service client and with an authorization agent, means for processing a request for service received from a service requester via the service client, and means for communicating with the authorization agent associated with the identified authorization information for authorizing the service request by applying an account-holder-configured authorization rule specific to the service requester. The request includes an identifier for identifying authorization information for the service requester. The service requester is one of a plurality of users associated with an account and authorization rules for different users associated with the account can be different.

In another aspect of the subject matter disclosed herein, a system for authorizing a service request based on account-holder-configured authorization rules includes a network interface configured for communicating with a service client and with an authorization agent, a service client interface component configured for processing a request for service received from a service requester via the service client, and an authorization component configured for communicating with the authorization agent associated with the identified authorization information for authorizing the service request by applying an account-holder-configured authorization rule specific to the service requester. The request includes an identifier for identifying authorization information for the service requester. The service requester is one of a plurality of users associated with an account and authorization rules for different users associated with the account can be different.

In another aspect of the subject matter disclosed herein, a system for authorizing a service request based on account-holder-configured authorization rules includes means for communicating with a service client and with a service provider, means for storing account-holder-configured authorization rules, and means for providing access for an account holder for defining the account-holder-configured authorization rules, for processing a request for authorization information from a service provider, and for providing the authorization information to the service provider in response to the request. The request for authorization information is associated with a request for service. The authorization information is based on application of at least one authorization rule and authorization rules for different service requesters associated with the account can be different.

In another aspect of the subject matter disclosed herein, a system for authorizing a service request based on account-holder-configured authorization rules includes a network services component configured for communicating with a service client and with a service provider, a rules data store configured for storing account-holder-configured authorization rules, and an authorization component configured for providing access for an account holder for defining the account-holder-configured authorization rules, for processing a request for authorization information from a service provider, and for providing the authorization information to the service provider in response to the request. The request for authorization information is associated with a request for service. The authorization information is based on application of at least one authorization rule and authorization rules for different service requesters associated with the account can be different.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 illustrates an arrangement for authorizing a service request based on account-holder-configured authorization rules according to an aspect of the subject matter disclosed herein;

FIGS. 2-6 are signaling diagrams illustrating different signaling scenarios according to different aspects of the subject matter disclosed herein;

FIG. 7 is a block diagram illustrating presence functionality that can be incorporated into communication components to enable pub/sub protocol communications with the authorization agent by the service provider and service client;

FIG. 8 is a flow diagram illustrating a method for authorizing a service request based on account-holder-configured authorization rules according to an aspect of the subject matter disclosed herein; and

FIG. 9 is a flow diagram illustrating a method for authorizing a service request based on account-holder-configured authorization rules according to another aspect of the subject matter disclosed.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

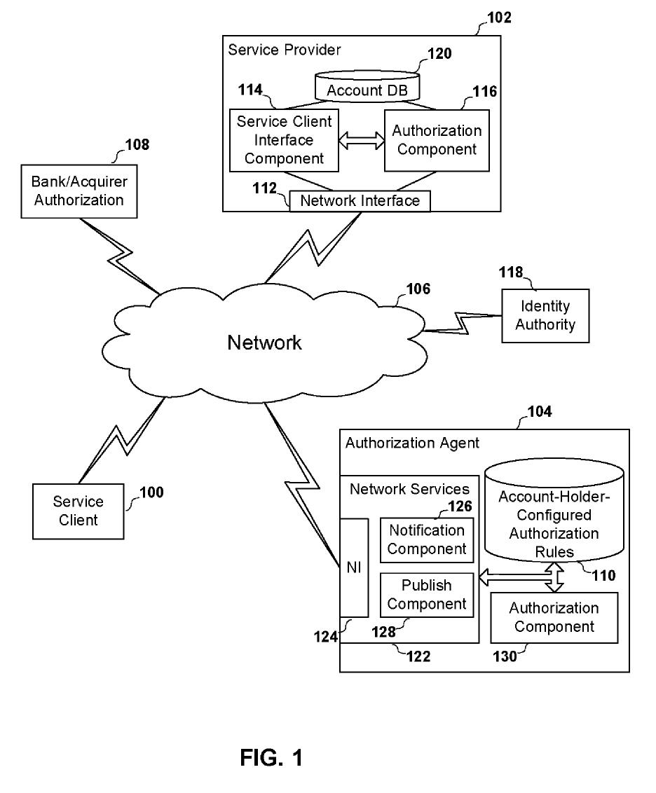

FIG. 1 illustrates an arrangement for authorizing a service request based on account-holder-configured authorization rules according to an aspect of the subject matter disclosed herein. In FIG. 1, a service client 100, a service provider 102, and an authorization agent 104 can communicate via a network 106, such as the Internet, a local area network, a wide area network, and the like. The service client 100 can be associated with a client device (not shown), such as a personal computer, mobile telephone, personal digital assistant, or other electronic device. The service client 100 can include a client application for communicating with the service provider 102 using any known communication protocol. For example, the service client 100 can include a browser such as MICROSOFT INTERNET EXPLORER or MOZILLA FIREFOX for communicating with the service provider 102 via an HTTP protocol.

The service provider 102 can be, for example, an e-commerce web site, a bricks-and-mortar retail store, an automotive service station, or any other known service provider 102 that provides goods or services. According to one aspect, the service client 100 can be a device and/or application operated by a user for requesting service from the service provider 102. For example, the service client 100 can be a browser communicating with a server hosting an e-commerce web site for the service provider 102. A user navigates to the web site and requests service from the service provider 102. In this case, the user becomes a service requester and the service provided by the service provider 102 is providing items for purchase to the user via the service client 100.

According to another aspect, the service client 100 can include a device and/or application used at a point-of-sale to receive a request for service from a user/service requester. For example, service client 100 can be a device and/or application operable as part of, or in conjunction with, a point-of-sale terminal operated by a store clerk at a brick-and-mortar retail store when processing a transaction for a user. In such a case, the user is still considered the service requester, since the user is requesting service from the service provider 102, i.e., requesting to purchase an item for sale. As used herein, the terms “service requester” and “user” are not limited to specific people, but may include agents acting on their behalf. For example, a different person can act on behalf of a service requester or user. Additionally, a digital agent including software and/or hardware, such as service client 100, can act on behalf of, or instead of, the service requester and/or user.

In operation, the service client 100 sends a request for service to the service provider 102. For example, service client 100 can send a service request including information provided by a user either directly, i.e., filling out a form on the service provider's e-commerce web site, or indirectly through a store clerk. The service provider 102 communicates with the authorization agent 104 to receive authorization to conduct the transaction. Authorization agent 104 provides authorization based on account-holder-configured authorization rules. In addition, the service provider 102 can communicate with a bank/acquirer authorization service 108 to authorize the transaction using a conventional bank/acquirer authorization procedure. Authorization agent 104 can also operate in conjunction with bank/acquirer authorization service 108. For example, bank/acquirer authorization service 108 can communicate with authorization agent 104 to provide a requested authorization to service provider 102.

The authorization provided by authorization agent 104 is not necessarily limited to financial transactions; non-financial transactions may be authorized as well. For example, a parent may create an online account with a web service. Instead of creating separate accounts with the service, the parent may configure account usage rules in authorization agent 104 for his children to restrict their use of the site further. This allows the user/parent to manage all sub-accounts independent of the service and further protect the data of his/her children since the personal info associated with the sub-accounts is not provided. Authorization agent 104 can merely indicate whether a request is authorized or not.

Authorization agent 104 can communicate via network 106 with any of service client 100, service provider 102, authorization agent 104, and bank/acquirer authorization service 108 using a commonly known protocol or protocols, such as hypertext transfer protocol (HTTP) or HTTP secure (HTTPS), and/or can communicate using other known protocols as well. According to aspects of the subject matter disclosed herein, authorization agent 104 uses a publication/subscribe (pub/sub) protocol to communicate with other entities. Generally, in a pub/sub protocol, senders of information (or publishers) post (or publish) messages with specific topics rather than sending messages to specific recipients. The pub/sub messaging system then selectively broadcasts the posted messages (through what are referred to as notify messages) to all interested parties, referred to as subscribers. The published information can be read simultaneously by any number of subscribing clients.

By way of example, aspects of the subject matter described here can employ a presence protocol as the pub/sub communications protocol. It should be understood, however, the relevant techniques described here can be performed using any pub/sub communications protocol. Additionally, the subject matter described herein is not limited to the use of a pub/sub protocol and any other known protocol can also be used. Presence information can be used to authorize a service requester by using a presence protocol and providing presence services. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society.

Authorization agent 104 can include one or more pub/sub servers used to provide pub/sub services. The function of the pub/sub server, however, can be incorporated, either in whole or in part, into any of the service client 100, the service provider 102, and/or the authorization agent 104. For example, the presence service model can be used. The presence service model described in RFC 2778 describes two distinct agents of a presence service client. The first of these agents, called a “presentity” (combining the terms “presence” and “entity”), provides presence information, which can include authorization information, to be stored and distributed throughout the presence service on behalf of a presence client. The second type of presence agent is referred to as a “watcher”. Watchers receive presence information from the authorization agent 104 on behalf of a presence client. The presence model of RFC 2778 describes types of watchers, referred to as “subscribers” and “fetchers”. A subscriber requests notification from the authorization agent 104 of a change in some presentity client's presence information. The authorization agent 104 establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher. A special kind of fetcher, referred to as a “poller”, is defined in the model that fetches information on a regular (or polling) basis.

The authorization agent 104 can also manage, store, and distribute presence information associated with watcher clients through their presentities, as well as the watcher clients' activities in terms of the fetching or subscribing to the presence information of other presence clients using the presence service. This “watcher activity information” can be distributed to other watcher clients by the authorization agent 104 using the same mechanisms that are available for distributing the presence information of presentity clients.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

It should also be understood that, as used herein, the term “presence information” can include any information associated with a service requester. In the presence model RFC 2778, status is defined as a distinguished part of presence information of a presentity. More particularly, RFC 2778 defines statuses of open and closed for use in instant messaging and other forms of communication. A status of open, for example, can indicate availability to receive communications (such as IM messages and can include any other forms of communications), while closed can be used to indicate unavailability. RFC 2778 also provides for status to include other values, which can consist of single or multiple values. For example, as described above, status can include information about maximum allowed balance, maximum allowed expenditures, authorized service requesters, and the like. Status can be very specific or broad. For example, status can provide information about a single service provider 102 or universally for all service provider 102s.

Accordingly, status can include forms and values not specifically mentioned in the presence model while omitting forms and values that are specifically mentioned, while staying within the model described in RFC 2778. It should therefore be understood that presence information, as used herein, is intended to cover all forms and values of status specifically mentioned in RFC 2778 and those not specifically mentioned.

The account holder-configured authorization rules can be stored in any form at (or accessible to) authorization agent 104 in a rules data storage component 110. Rules data storage component 110 can be a database for example. In one implementation, the rules are stored and organized into portions referred to as tuples. As will be understood by those skilled in the art, a tuple, in its broadest sense, is a data object containing one or more components. For example, although not required, the rules can be stored in presence tuples. Presence tuples include the status of a principal of a presence service, but can also include additional information. A presence tuple can include an identifier of a principal and the principal's status, contact address, and other information. Since presence tuples are extendible, additional information can be added which can further serve to verify a service requester's authority. For example, a presence tuple can contain information regarding agents who can act on behalf of the service requester and the activities they are allowed to perform in this role. It should be understood, therefore, that presence information can contain multiple status values that can be broad indicators and/or precise indicators of the service requester's presence. The service provider 102 can obtain authorization based on account-holder-configured authorization rules that are stored in one or more tuples. For example, the tuples can include information that identifies an account user (such as a child or employee of the account holder), and include authorization rules specific to that account user. Information may also be combined in any fashion for authorization purposes. For example, an authorization rule could set forth a maximum expense per transaction, or overall, that is specific to a given service provider 102. The authorization rules comprise authorization information configured under the control of the account holder. Examples of authorization rules are shown in Table 1. In the example shown in Table 1, the authorization information is for a parent/account holder having their children as additional users on the account that can thus act as a service requester. Table 1 includes, for each user, a maximum current balance, a maximum expense per transaction, and a list of service providers for which that user is authorized.

TABLE 1
Account-Holder-Configured Authorization Rules

| | User | | Maximum | |
|---|---|---|---|---|
| Account | (Service | Maximum | Expense Per | Allowable Service |
| Holder | Requester) | Balance | Transaction | Providers |
| Ben Parent- | Adam | $2,000 | $300 | Unlimited |
| Account No. | Hoss | $1,500 | $300 | Ponderosa Steak |
| 123-456-78 | | | | House |
| | | | | Carson City Big and |
| | | | | Tall Men's Shop |
| | | | | Saddles-R-Us.com |
| | Little Joe | $1,000 | $200 | Burning Map |
| | | | | Campus |
| | | | | Book Store |
| | | | | McDonalds Feed |
| | | | | Store |
| | | | | Hop Sing Chinese |
| | | | | Restaurant |
| | | | | WesternBride.com |

It should be understood that the authorization information can include a variety of information related to the account. For example, the account holder can use a field in the authorization information to report a credit card status as “lost credit card” before officially reporting the card lost to the credit card issuer, if the account holder thinks the card was misplaced. If the card is found later, the status is simply changed without the account holder having to go through the hassle of canceling the card and having a new one issued. Similarly, the account holder can use a field in the authorization information to report a service requester's privileges revoked to revoke a service requester's privileges either temporarily or permanently without affecting other users on the account.

Returning again to FIG. 1, the service provider 102 includes a system for authorizing a service request based on account-holder-configured authorization rules. The service provider 102 includes means for communicating with a service client 100 and with a presence service. For example, the service provider 102 includes a network interface 112 configured for communicating with the service client 100 and with the authorization agent 104 using any known protocol or protocols. In example, the network interface 112 can include network services for communicating with the service client 100 using a hypertext transport protocol (HTTP) and with the authorization agent 104 using a pub/sub protocol.

The service provider 102 also includes means for processing a request for service received from a service requester via the service client. For example, the service provider 102 can include a service client 100 interface component 114 configured for processing a request for service received from a service requester via the service client. The request can include an identifier for identifying authorization information for the service requester. As described above, the service requester can be one of a plurality of users associated with an account. The service client 100 interface component 114 is capable of processing requests for service from the service client 100 received. The service client 100 can be configured to process requests received via known protocols at network interface 112.

The request includes an identifier for identifying presence information for the service requester. According to one aspect, the request includes a universal resource indicator (URI), such as a universal resource locator (URL), to identify presence information for the service requester at authorization agent 104. For example, the request can include a form submission from a browser at service client 100 that includes a URL that identifies an address that defines the route to the authorization agent 104. The identifier can be sent automatically with every request or only in specific situations as determined by the browser base on a predetermined configuration. URL's typically contain a protocol prefix (such as http:), the port number, domain name, subdirectory name, and file name. If a port number is not stated in the address, a default port is used. For example, port 80 is used as the default port for HTTP traffic. URL's are not limited to identifying HTTP resources and can be used to identify other resources.

According to another aspect, the request can additionally, or alternatively, include an identifier for correlating the request to presence information for the service requester. For example, the request can include an identifier that identifies a message to be received (or that is already received) from the authorization agent 104. The presence service message includes the same identifier, and can therefore be correlated to the request for service. As will be appreciated by one of ordinary skill in this art, a correlation between the request for service and a message received from a presence service can be accomplished using various other techniques. It should therefore be understood that any known technique for correlating requests with messages can be used according to the subject matter described herein.

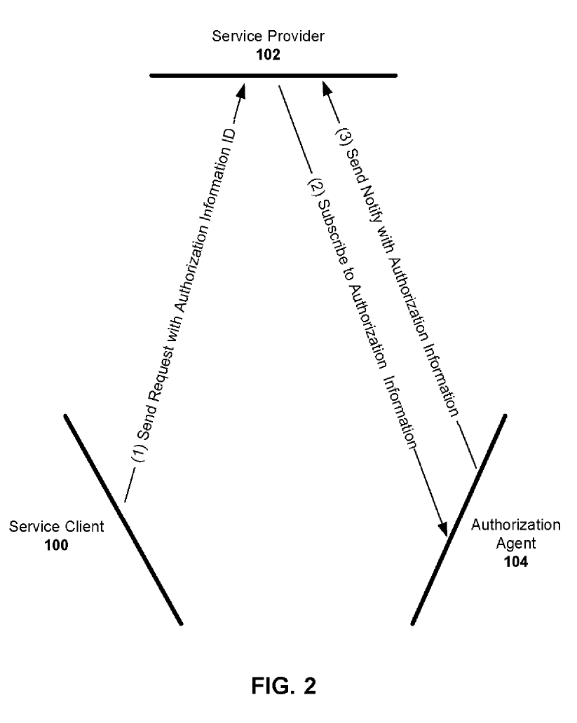

The service provider 102 also includes means for communicating with the authorization agent 104 associated with the identified authorization information for authorizing the service request by applying an account-holder-configured authorization rule specific to the service requester. For example, the service provider 102 can include an authorization component 116 configured for communicating with the authorization agent 104 associated with the identified authorization information for authorizing the service request by applying an account-holder-configured authorization rule specific to the service requester, as will be discussed further below in connection with FIGS. 2-6. The authorization rules for different users associated with the account can be different, as shown in Table 1.

To authorize a service request, information about the request for service can be compared to the service requester's authorization information. The information about the request for service can include information about a location associated with the request for service, such as an identifier for the service requester, an identifier for service provider 102, an amount required for the transaction, and the like. The information about the request for service can also include a certificate verifying an identity of the service provider 102 to the authorization agent 104. Referring again to FIG. 1, an identity authority 118 can issue a token or certificate to the service provider 102 to authenticate the service provider's identity to the authorization agent 104 and/or to the service client 100 during communications. Similarly, service client 100 or the presence service can obtain a token or certificate issued by the identity authority 118 to confirm their identity to the other respective entities during communications. The identity authority 118 can be, for instance, a certificate authority such as VERISIGN or THAWTE.

The service provider 102 can also include an account database 120 for storing and managing customer account information. The management of customer account information can include the management of information about service requests and/or authorization information for service requesters.

According to another aspect, the authorization agent 104 includes a system for authorizing a service request based on account-holder-configured authorization rules. As illustrated in FIG. 1, the authorization agent 104 includes means for communicating with a service client 100 and with a service provider 102. For example, authorization agent 104 can include a network services component 122 configured for communicating with the service client 100 and with the service provider 102. The network services component 122 can include a network interface 124, a notification component 126, and a publish component 128. The network interface 124 is configured to provide communication via the network 106 using any known protocol. The notification component 126 is configured to process subscribe messages and provides notification messages according to a pub/sub protocol. The publish component 128 is configured to process received publish messages according to a pub/sub protocol.

Authorization agent 104 also includes means for storing account-holder-configured authorization rules. For example, as mentioned above, authorization agent 104 can include the rules data store 110. The rules data store 110 can be at authorization agent 104 or can be remotely accessible.

Authorization agent 104 also includes means for providing access for an account holder for defining the account-holder-configured authorization rules, for processing a request for authorization information from a service provider 102, and for providing the authorization information to the service provider 102 in response to the request. For example, authorization agent 104 can include an authorization component 130 configured to perform these functions.

The authorization agent 104 can provide access for an account holder for defining the account-holder-configured authorization rules. For example, the account holder can access the authorization agent 104 via a user interface to define rules to be applied in authorizing users on the account, similar to the rules illustrated in Table 1. The account holder can access the authorization agent 104 via a user interface either directly or from the service client 100 via network 106.

Authorization agent 104 can also process a request for authorization information from a service provider 102 and provide the authorization information to the service provider 102 in response to the request. Each of these functions is discussed further below in connection with the signaling scenarios illustrated in FIGS. 2-6. In each case, the request for authorization information is associated with a request for service, the authorization information is based on application of at least one authorization rule, and authorization rules for different service requesters associated with the account can be different.

FIGS. 2-6 are signaling diagrams illustrating different signaling scenarios according to different aspects of the subject matter disclosed herein. In FIG. 2, the service client 100 sends a request to the service provider 102 that includes an identifier identifying the authorization information. For example, the request can include a URL identifying the authorization agent 104 and/or the service requester. The service provider 102, using the identifier, subscribes to the service requester's presence tuple at the authorization agent 104. The authorization agent 104 responds by sending a notify message including the authorization information to the service provider 102. The authorization component 130 of the authorization agent 104 can perform some level of authorization to determine whether the service provider 102 is authorized to receive the authorization information. For example, the authorization component 130 can check a certificate provided by the service provider 102 to authenticate its identity to the authorization agent 104. Alternatively, the service provider 102 can be required to provide a password for authentication.

According to the aspect illustrated in FIG. 2, the authorization component 116 at the service provider 102 is configured to communicate with the authorization agent 104 associated with the identified authorization information for verifying an identity of the service requester by subscribing to authorization information associated with the account holder and receiving one or more notification messages including authorization information for the service requester. The authorization agent 104 is configured for receiving from the service provider 102 the subscribe message for subscribing to authorization information for a service requester and for sending a notify message with the authorization information to the service provider 102. For example, the notification component 126 can be configured for performing some or all of these functions.

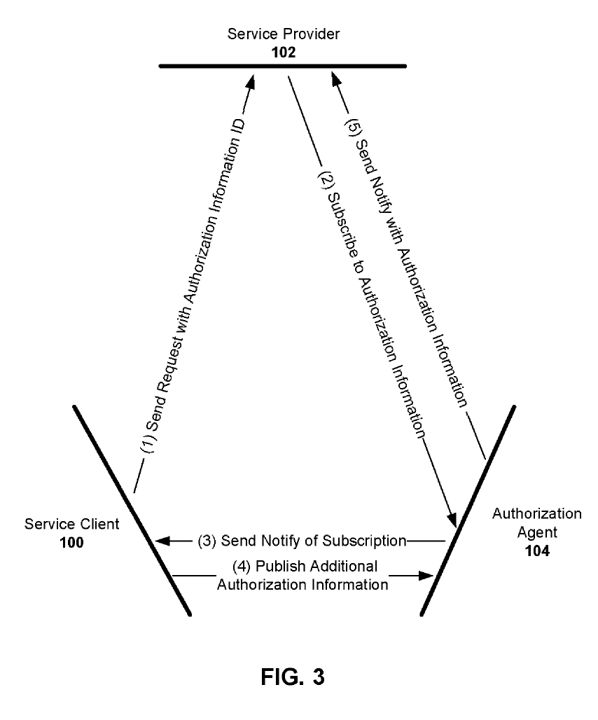

In FIG. 3, the service client 100 sends a request to the service provider 102 that includes an identifier identifying the authorization information. The service provider 102, using the identifier, subscribes to the service requester's authorization information at the authorization agent 104. The authorization agent 104 sends a notify message to the service client 100 for requesting authorization to provide the service provider 102 with the authorization information. The notify message can include information identifying the service provider 102. The service client 100 publishes additional authorization information to the authorization agent 104. The additional authorization information can be used to change or supplement the authorization information for the account stored at the authorization agent 104. For example, the service client 100 can be a browser operated by the service requester and can present a message to the service requester indicating that the service provider 102 has requested authorization information and can provide detailed information about a transaction, such as a credit card used, location, etc. The service requester can then supplement the authorization information with additional authorization information or change the authorization information. The service requester can be authorized by the account holder to make such changes and may be required to present proof of the account holder permission to the authorization agent 104. The authorization agent 104 responds by sending a notify message including the additional authorization information to the service provider 102.

Alternatively, or in addition, the service requester can decide whether to authorize the sending of authorization information to the service provider 102. More particularly, the additional authorization information can serve as a release to authorize releasing the account-related authorization information to the service provider 102. Should the service requester choose to withhold the release authorization; the service request can be denied. The release authorization can be used to prevent unauthorized access to the authorization information stored at authorization agent 104.

In either case, the service requester's response results in a generation of a publish message with the additional authorization information at service client 100 that is forwarded to the authorization agent 104. In cases where the authorization information is released, the authorization agent 104 can then forward a notify message to the service provider 102 that includes the authorization information and any additional authorization information provided by the service client 100.

According to the aspect illustrated in FIG. 3, the authorization component 116 at the service provider 102 is configured to send a subscribe message for subscribing to authorization information associated with the account holder and to receive a notification message including authorization information for the service requester.

Also according to the aspect illustrated in FIG. 3, the authorization component 130 at the authorization agent 104 is configured for receiving from the service provider 102 a subscribe message for subscribing to authorization information for a service requester and for sending a notify message with the authorization information to the service provider 102. The authorization component 130 is further configured for sending a notify message that indicates the subscribe message has been received to a service client 100 associated with the service requester and receiving a publish message that includes additional authorization information from the service client. For example, the publish component 128 can process the publish message. A notify message is then sent to the service provider with the authorization information and the additional authorization information.

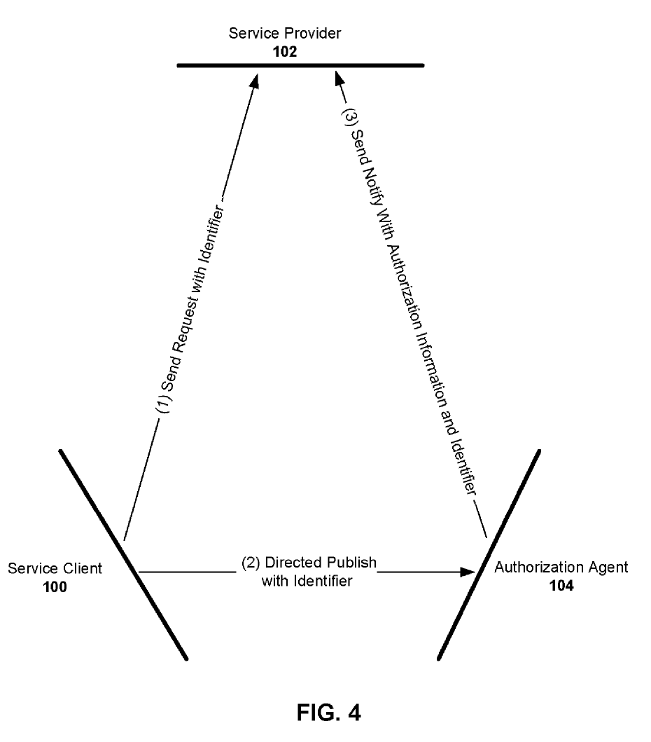

In FIG. 4, the service client 100 sends a request with the identifier to the service provider 102. The service client 100 also sends a directed publish message with the identifier to the authorization agent 104 for identifying the authorization information for the account holder. The authorization agent 104 provides the requested authorization information in a notify message identified by the identifier to the service provider 102. As discussed above, the identifier can be any identifier or other means that can be used for correlating the request for service with the provided notify message at the service provider 102.

According to the aspect illustrated in FIG. 4, the authorization component 116 at the service provider 102 is configured to communicate with the authorization agent 104 for receiving at least one notification message including authorization information for the service requester and an identifier and correlating the at least one notification message to the request for service based on the identifier.

Also according to the aspect illustrated in FIG. 4, the authorization component 130 at the authorization agent 104 is configured for receiving a publish message from a service client 100 requesting service for a service requester from a service provider 102 and sending a notify message to the service provider 102 including the identifier and authorization information for the service requester. The publish message includes an identifier for correlating a request for service to authorization information for the service requester.

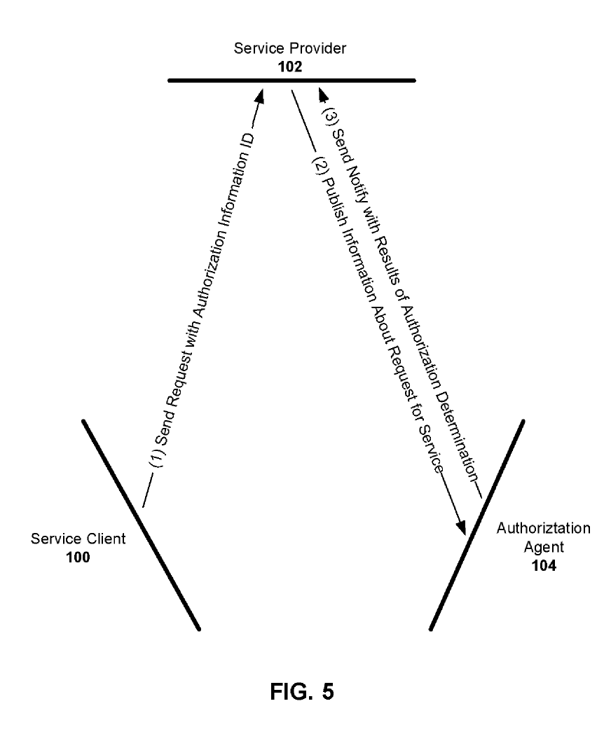

In FIG. 5, the service client 100 sends a request with the identifier to the service provider 102. The service provider 102 sends a publish message to the authorization agent 104. The publish message includes information about the request for service, such as account holder identification, service requester identification, a service provider identifier, and/or a cost for the transaction. The request for service can also include a certificate verifying an identity of the service provider 102 to the authorization agent 104. The authorization component 130 compares the information about the request for service to authorization information associated with the account holder and, based on the comparison, determines whether the service request is authorized. The authorization agent 104 sends a notify message to the service provider 102 with an indication as to the results of the authorization determination. For example, the indication could be authorized or not authorized.

According to the aspect illustrated in FIG. 5, the authorization component 116 at the service provider 102 is configured to communicate with the authorization agent for publishing information about the request for service to the authorization agent and receiving a notification message indicating whether the service requester is authorized.

Also according to the aspect illustrated in FIG. 5, the authorization component 130 at the authorization agent 104 is configured for receiving a publish message including information about the service request, determining whether the service request is authorized based on the information about the service request and the authorization information, and sending a notify message to the service provider 102 with an authorization indication for indicating a result of the authorization determination.

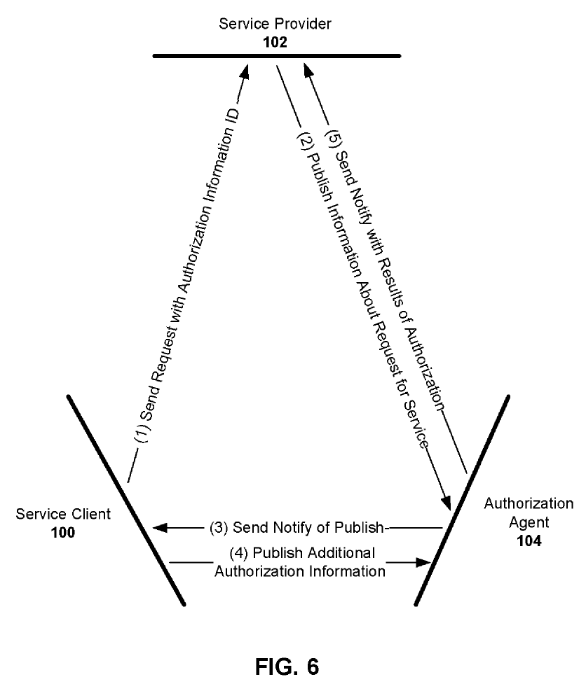

In FIG. 6, the service provider 102 and authorization agent 104 perform similar functions as described above with reference to FIG. 5, but provide for additional functionality for receiving additional authorization information from service client 100. The authorization component 130 of the authorization agent 104, upon receiving the publish message from the service provider 102, sends a notify message to the service client 100 providing information about the request for service. The service client 100 publishes additional authorization information to the authorization agent 104. The authorization agent 104 responds by sending, based on the authorization, a notify message including the results of the authorization determination to the service provider 102.

According to this aspect, the service client 100 is given an opportunity to provide or deny authorization for the service request. For example, the service client 100 can be a browser operated by the service requester and can present a message to the service requester indicating that the service provider 102 has requested authorization information and can provide detailed information about a transaction, such as a credit card used, cost, service requester, account holder, etc. The account holder and/or service requester can then decide whether to authorize the transaction by responding to the message prompt. The response results in a generation of a publish message with the authorization information. Alternatively, or in addition, the additional authorization information can be used to update authorization information stored at the authorization agent 104.

According to the aspect shown in FIG. 6, the authorization component 116 at the service provider 102 is configured for publishing information about the request for service to the authorization agent and receiving a notification message indicating whether the service requester is authorized.

According to the aspect shown in FIG. 6, the authorization component 130 at the authorization agent 104 is configured to determine whether the service request is authorized by sending a notify message to a service client associated with the service requester, receiving a publish message from the service client, the publish message including additional authorization information, and determining whether the service request is authorized based on the information about the service request, the authorization information, and the additional authorization information.

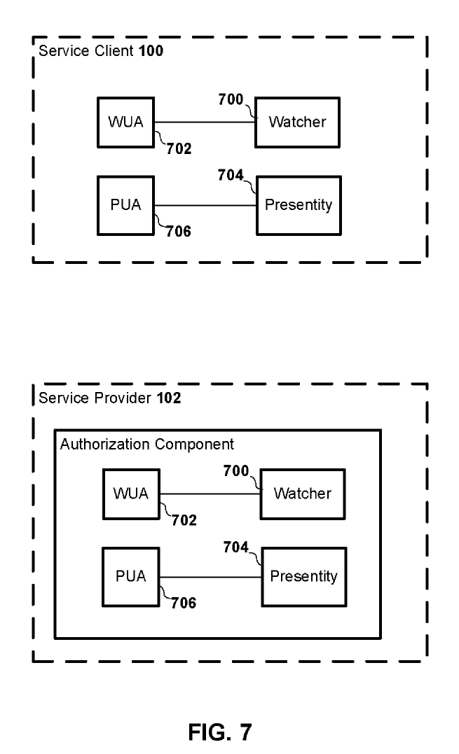

FIG. 7 is a block diagram illustrating pub/sub functionality that can be incorporated into communication components to enable pub/sub protocol (e.g., presence protocol) communications with the authorization agent 104 by the service provider 102 and service client 100. In FIG. 7, the service client 100 includes a watcher 700 configured to request a subscription to a tuple including authorization information and an associated WUA 702 configured to receive an identifier for the tuple entered by a user (e.g. via an entry in a user interface (not shown), for example). The WUA 702 can pass the identifier to the watcher 700, which then requests the subscription to the tuple. The tuple is stored at the authorization agent 104 in the data store 110. The watcher 700 can send the request for a subscription to the tuple to the authorization agent 104, which is processed by the notification component 126. The notification component 126 is configured to respond by sending notifications to the watcher client 700 of the service client 100 pursuant to the subscription.

The service client 100 can also include a presentity 704 and an associated PUA 706. The presentity/PUA 704, 706 can be configured to publish changes to the authorization information to the tuple at the authorization agent 104. The publish component 128 at the authorization agent 104 is configured to process the publish messages and update the tuple accordingly. For example, the presentity/PUA 704, 706 can be configured to publish additional authorization information as shown in FIG. 3 or 6.

The authorization component 116 at the service provider 102 can also include a watcher 700 and a WUA 702. The watcher/WUA 700, 702 can be configured for subscribing to a tuple containing authorization information at the authorization agent 104 for receiving notifications including the authorization information as illustrated in FIGS. 2-4 or for receiving notifications including a verification as illustrated in FIGS. 5 and 6.

The authorization component 116 can also include a presentity 704 and an associated PUA 706. The presentity/PUA 704, 706 can be configured to publish information about the request for service to the tuple at the authorization agent 104 as shown in FIGS. 5 and 6. The publish component 128 at the authorization agent 104 is configured to process the publish messages and update the tuple accordingly.

One skilled in this art will observe that the names of the components described above correspond to the components of the presence model defined in RFC 2778 to Day et al., titled “A Model for Presence and Instant Messaging” (IETF, February 2000). It should be understood that the described functions, namely the publish, notify, and subscribe functions, can be incorporated as defined in RFC 2778 including any variations and/or modifications known to one of ordinary skill in this art.

It should also be understood that communications between the service client 100, the service provider 102, and the authorization agent 104 are not necessarily limited to a presence protocol and can be carried out using any known communication protocol. For example, requests for service can be made using HTTP requests and responses. Requests can be made using the HTTP Get or Post method. The HTTP Post method is particularly useful for form submissions to a web server. For example, an HTTP Post can be used to submit a form by the service client 100 to the service provider 102. HTTP also includes several other request methods, such as a Get method, as well as response messages that are suitable to carry out the subject matter described herein. Other protocols can also be employed.

It should further be understood that the various components illustrated in the Figures represent logical components that are configured to perform the functionality described herein and can be implemented in software, hardware, or a combination of the two. Moreover, some or all of these logical components can be combined and some can be omitted altogether while still achieving the functionality described herein.

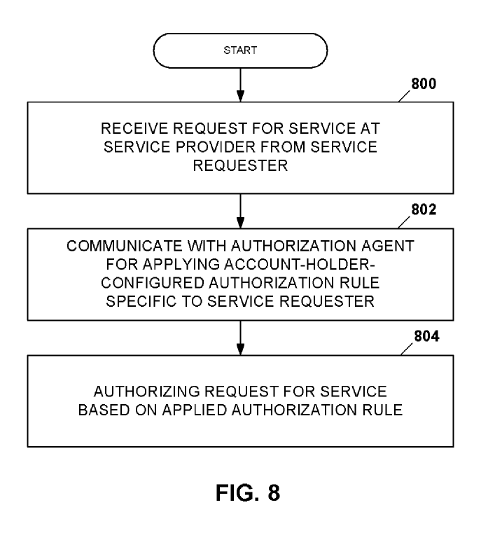

FIG. 8 is a flow diagram illustrating a method for authorizing a service request based on account-holder-configured authorization rules. In block 800, the service provider 102 receives a request for service from a service requester. The service requester is one of a plurality of users associated with an account. In block 802, the service provider 102 communicates with an authorization agent 104 for applying an account-holder-configured authorization rule specific to the service requester. The service provider 102 authorizes the request for service based on the applied authorization rule in block 804.

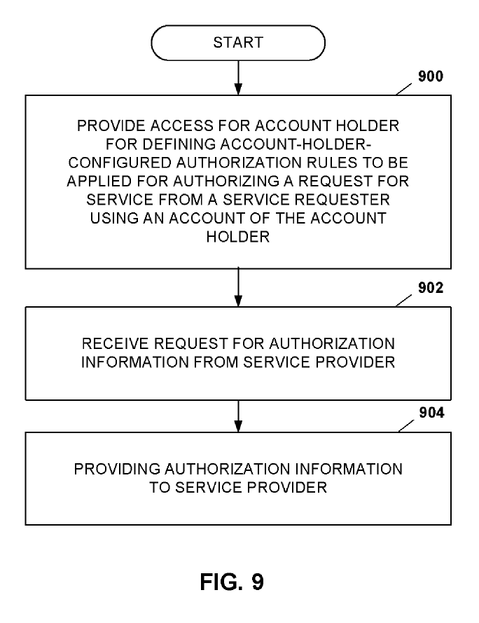

FIG. 9 is a flow diagram illustrating a method for authorizing a service request based on account-holder-configured authorization rules. In block 900, access to the authorization agent 104 for an account holder is provided for defining account-holder-configured authorization rules to be applied by the authorization agent 104 for authorizing a request for service from a service requester using an account of the account holder. The authorization agent 104 receives a request for authorization information from a service provider 102 in block 902. The request for authorization information is associated with a request for service. In block 904, the authorization agent 104 provides the authorization information to the service provider 102. The authorization information is based on application of at least one authorization rule. Authorization rules for different service requesters associated with the account can be different.

Exemplary Scenarios

Scenario 1: Buy a Book at Local Bookstore

1. Joe provides a credit card to a retail store to purchase some items totaling $250.00. His father Ben is the account holder for the credit card. Ben has made Joe a user on the account subject to Ben's authorization rules.

3. The store has a URL for accessing Ben's authorization information on an authorization agent.

2. The store clerk requests authorization from the authorization agent.

4. The store's account system automatically matches the authorization information against the store name to see if Joe is authorized to shop there and against the amount for the transaction to make sure Ben has authorized Joe for a single transaction amount of $250.00.

5. The authorization information indicates Joe is only authorized to spend $200.00 in a transaction (service request).

6. The transaction is not authorized.

Scenario 2: Arriving at Work

1. Larry arrives at work and slides his badge into the badge reader.

2. The badge reader checks the ID on the badge against its database for authorizing entrance.

3. The security system has a subscription to all employee authorization information.

4. The security system determines that Larry is not allowed to enter the building through the current entry based on the authorization information. He is only allowed to enter through the front entry while a receptionist is present.

5. The lock on the door is not released.

Scenario 3: Online Request

1. Larry's son, Lars, logs into Larry's bank account at MyTown Bank.

2. He initiates a transaction to transfer $10,000 to an account in another bank.

3. Lar's browser is set to send a directed publish to initiate a notify to a watcher in an authorization agent associated with the URL the request was sent to (i.e. MyTown Bank). The watcher's presence address is obtained from metadata in the web page.

4. Data in a tuple stored at Larry's authorization agent authorizes Lars as Larry's agent for MyTown Bank and includes the URL for Lars' authorization information.

5. Larry's authorization agent redirects the directed publish to Lars' authorization agent. Lars' authorization agent sends MyTown Bank a directed notify with information from Larry's tuple authorizing Lars as his agent. Information is also provided from Lars' tuple to aid in authenticating Lars, including a secret passcode only Lars and Larry know.

6. The Bank returns a web page to Lars' browser prompting for the secret passcode. Lars enters the passcode.

7. MyTown authorizes the transfer.

It will be understood that various details of the invention can be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for authorizing a service request based on account-holder-configured authorization rules, the method comprising:
receiving a request for service at a service provider from a service requester, wherein the service requester is one of a plurality of users associated with an account;
communicating with an authorization agent for applying an account-holder-configured authorization rule specific to the service requester, wherein authorization rules for different users associated with the account can be different; and
authorizing the request for service based on the applied authorization rule.

2. The method of claim 1 wherein communicating with an authorization agent for applying an account-holder-configured authorization rule specific to the service requester comprises:
subscribing to authorization information associated with the account holder; and receiving a notification message including authorization information for the service requester.

3. The method of claim 1 wherein communicating with an authorization agent for applying an account-holder-configured authorization rule specific to the service requester comprises:
receiving at least one notification message including authorization information for the service requester and an identifier; and
correlating the at least one notification message to the request for service based on the identifier.

4. The method of claim 1 wherein communicating with an authorization agent for applying an account-holder-configured authorization rule specific to the service requester comprises:
publishing information about the request for service to the authorization agent; and
receiving a notification message indicating whether the service requester is authorized.

5. The method of claim 1 wherein the authorization rule includes at least one of a maximum allowable balance, a maximum allowable expenditure for a transaction, an authorized service provider, and any combination thereof.

6. The method of claim 1 wherein communicating with an authorization agent for applying an account-holder-configured authorization rule specific to the service requester includes providing a certificate verifying an identity of the service provider to the authorization agent.

7. A method for authorizing a service request based on account-holder-configured authorization rules, the method comprising:
providing access for an account holder for defining account-holder-configured authorization rules to be applied for authorizing a request for service from a service requester using an account of the account holder;
receiving a request for authorization information from a service provider, wherein the request for authorization information is associated with a request for service; and
providing the authorization information to the service provider;
wherein the authorization information is based on application of at least one authorization rule and wherein authorization rules for different service requesters associated with the account can be different.

8. The method of claim 7, wherein receiving a request for authorization information from a service provider and providing the authorization information to the service provider comprises:
receiving from the service provider a subscribe message for subscribing to authorization information for a service requester; and
sending a notify message with the authorization information to the service provider.

9. The method of claim 8, comprising:
sending a notify message to a service client associated with the service requester, the notify message indicating that the subscribe message has been received;
receiving a publish message from the service client, the publish message including additional authorization information; and
sending the notify message to the service provider with the authorization information and the additional authorization information.

10. The method of claim 7, wherein receiving a request for authorization information from a service provider and providing the authorization information to the service provider comprises:
receiving a publish message from a service client requesting service for a service requester from a service provider, the publish message including an identifier for correlating a request for service to authorization information for the service requester; and
sending a notify message to the service provider including the identifier and authorization information for the service requester.

11. The method of claim 7, wherein receiving a request for authorization information from a service provider and providing the authorization information to the service provider comprises:
receiving a publish message including information about the service request;
determining whether the service request is authorized based on the information about the service request and the authorization information; and
sending a notify message to the service provider with an authorization indication for indicating a results of the authorization determination.

12. The method of claim 11, wherein determining whether the service request is authorized comprises:
sending a notify message to a service client associated with the service requester, the notify message indicating that the publish message has been received;
receiving a publish message from the service client, the publish message including additional authorization information;
determining whether the service request is authorized based on the information about the service request, the authorization information, and the additional authorization information.

13. The method of claim 7 wherein the authorization rule includes at least one of a maximum allowable balance, a maximum allowable expenditure for a transaction, an authorized service provider, and any combination thereof.

14. A computer program product comprising computer executable instructions embodied in a computer-readable medium for performing steps comprising:
receiving a request for service at a service provider from a service requester, wherein the service requester is one of a plurality of users associated with an account;
communicating with an authorization agent for applying an account-holder-configured authorization rule specific to the service requester, wherein authorization rules for different users associated with the account can be different; and
authorizing the request for service based on the applied authorization rule.

15. A computer program product comprising computer executable instructions embodied in a computer-readable medium for performing steps comprising:
providing access for an account holder for defining account-holder-configured authorization rules to be applied for authorizing a request for service from a service requester using an account of the account holder;
receiving a request for authorization information from a service provider, wherein the request for authorization information is associated with a request for service; and
providing the authorization information to the service provider;
wherein the authorization information is based on application of at least one authorization rule and wherein authorization rules for different service requesters associated with the account can be different.

16. A system for authorizing a service request based on account-holder-configured authorization rules, the system comprising:
means for communicating with a service client and with an authorization agent;
means for processing a request for service received from a service requester via the service client, the request including an identifier for identifying authorization information for the service requester, wherein the service requester is one of a plurality of users associated with an account; and
means for communicating with the authorization agent associated with the identified authorization information for authorizing the service request by applying an account-holder-configured authorization rule specific to the service requester, wherein authorization rules for different users associated with the account can be different.

17. A system for authorizing a service request based on account-holder-configured authorization rules, the system comprising:
a network interface configured for communicating with a service client and with an authorization agent;
a service client interface component configured for processing a request for service received from a service requester via the service client, the request including an identifier for identifying authorization information for the service requester, wherein the service requester is one of a plurality of users associated with an account; and
an authorization component configured for communicating with the authorization agent associated with the identified authorization information for authorizing the service request by applying an account-holder-configured authorization rule specific to the service requester, wherein authorization rules for different users associated with the account can be different.

18. The system of claim 17 wherein the authorization component is configured to communicate with the authorization agent for:
subscribing to authorization information associated with the account holder; and
receiving a notification message including authorization information for the service requester.

19. The system of claim 17 wherein the authorization component is configured to communicate with the authorization agent for:
receiving at least one notification message including authorization information for the service requester and an identifier; and
correlating the at least one notification message to the request for service based on the identifier.

20. The system of claim 17 wherein the authorization component is configured to communicate with the authorization agent for:
publishing information about the request for service to the authorization agent; and
receiving a notification message indicating whether the service requester is authorized.

21. The system of claim 17 wherein the authorization rule includes at least one of a maximum allowable balance, a maximum allowable expenditure for a transaction, an authorized service provider, and any combination thereof.

22. The system of claim 17 wherein the authorization component is configured to communicate with the authorization agent for providing a certificate verifying an identity of the service provider to the authorization agent.

23. A system for authorizing a service request based on account-holder-configured authorization rules, the system comprising:
means for communicating with a service client and with a service provider;
means for storing account-holder-configured authorization rules; and
means for:
providing access for an account holder for defining the account-holder-configured authorization rules,
processing a request for authorization information from a service provider, and
providing the authorization information to the service provider in response to the request;
wherein the request for authorization information is associated with a request for service, the authorization information is based on application of at least one authorization rule, and authorization rules for different service requesters associated with the account can be different.

24. A system for authorizing a service request based on account-holder-configured authorization rules, the system comprising:
a network services component configured for communicating with a service client and with a service provider;
a rules data store configured for storing account-holder-configured authorization rules; and
an authorization component configured for:
providing access for an account holder for defining the account-holder-configured authorization rules,
processing a request for authorization information from a service provider, and
for providing the authorization information to the service provider in response to the request;
wherein the request for authorization information is associated with a request for service, the authorization information is based on application of at least one authorization rule, and authorization rules for different service requesters associated with the account can be different.

25. The system of claim 24, wherein the authorization component is configured for:
receiving from the service provider a subscribe message for subscribing to authorization information for a service requester; and
sending a notify message with the authorization information to the service provider.

26. The system of claim 25, wherein the authorization component is further configured for:
sending a notify message to a service client associated with the service requester, the notify message indicating that the subscribe message has been received;
receiving a publish message from the service client, the publish message including additional authorization information; and
sending the notify message to the service provider with the authorization information and the additional authorization information.

27. The system of claim 24, wherein the authorization component is configured for:
receiving a publish message from a service client requesting service for a service requester from a service provider, the publish message including an identifier for correlating a request for service to authorization information for the service requester; and
sending a notify message to the service provider including the identifier and authorization information for the service requester.

28. The system of claim 24, wherein the authorization component is configured for:
receiving a publish message including information about the service request;
determining whether the service request is authorized based on the information about the service request and the authorization information; and
sending a notify message to the service provider with an authorization indication for indicating a result of the authorization determination.

29. The system of claim 28, wherein the authorization component is configured to determine whether the service request is authorized by:
sending a notify message to a service client associated with the service requester, the notify message indicating that the publish message has been received;
receiving a publish message from the service client, the publish message including additional authorization information;
determining whether the service request is authorized based on the information about the service request, the authorization information, and the additional authorization information.

30. The system of claim 24 wherein the authorization rule includes at least one of a maximum allowable balance, a maximum allowable expenditure for a transaction, an authorized service provider, and any combination thereof.
